(19) United States
(12) Patent Application Publication
(10) Pub. No.: US 2012/0034008 A1
(43) Pub. Date: Feb. 9, 2012

(54) SEPARATING DEVICE AND IMAGE FORMING APPARATUS

(76) Inventor: Toshiki TAKIGUCHI, Osaka (JP)

(21) Appl. No.: 13/183,740

(22) Filed: Jul. 15, 2011

(30) Foreign Application Priority Data
Aug. 3, 2010 (JP) 2010-174462

(51) Int. Cl. G03G 15/00

(52) U.S. Cl. 399/397

(57) ABSTRACT

A separating device includes an intermediate transfer belt drive roller disposed in a convey path so as to convey a recording medium, a separating claw disposed to be opposed to the intermediate transfer belt drive roller so as to separate the recording medium by the tip. A part of the intermediate transfer belt drive roller to which the separating claw is opposed is made of material having higher hardness than the tip of the separating claw.

### CROSS REFERENCE

This Nonprovisional application claims priority under 35 U.S.C. §119(a) on Patent Application No. 2010-174462 filed in Japan on Aug. 3, 2010, the entire contents of which are hereby incorporated by reference.

### BACKGROUND OF THE INVENTION

The present invention relates to a separating device including a separating claw for separating a recording medium winding around a roller or an endless belt, and to an image forming apparatus.

Conventionally, there is an image forming apparatus that transfers a toner image formed on a photoconductor drum to an intermediate transfer belt, and further transfers the toner image from the intermediate transfer belt to a paper sheet, so as to form an image on the paper sheet. Such an image forming apparatus is equipped with a separating claw disposed to be opposed to the intermediate transfer belt, so that the separating claw separates a paper sheet winding around the intermediate transfer belt when the toner image is transferred (see JP-A-2009-204768).

In addition, there is an image forming apparatus equipped with an intermediate transfer roller instead of the intermediate transfer belt, and a separating claw disposed to be opposed to the intermediate transfer roller (see JP-A-2006-91088).

In the image forming apparatus described in JP-A-2009-204768, as image forming apparatus 200 illustrated in FIG. 1, if a jam (paper jam) occurs in a fixing device 15, for example, while a paper sheet P (illustrated by a dot line) is being conveyed, the paper sheet P is folded and presses a separating claw 21, so that the tip of the separating claw 21 may be pressed to the outer circumferential surface of an intermediate transfer belt 6. In this case, because the separating claw 21 has higher hardness than an intermediate transfer belt drive roller 62, the intermediate transfer belt drive roller 62 may suffer damage such as a scratch or a dent.

This problem occurs also in the image forming apparatus described in JP-A-2006-91088 in the same manner. Specifically, when a jam occurs, the separating claw is pressed to the intermediate transfer roller, and the intermediate transfer roller is damaged.

An object of the present invention is to provide a separating device that does not damage the roller even if the separating claw for separating a recording medium contacts the opposed roller, and to provide an image forming apparatus equipped with the separating device.

### SUMMARY OF THE INVENTION

A separating device of the present invention includes a roller and a separating claw. The roller is disposed in a convey path for conveying a recording medium. The separating claw is disposed to be opposed to the roller so as to separate a recording medium by the tip. In addition, a part of the roller to which the separating claw is opposed is made of material having higher hardness than the tip of the separating claw.

In the case where the separating claw is disposed to be opposed to the roller, if a jam occurs and a recording medium is folded, the recording medium presses the separating claw, so that the tip of the separating claw may be pressed to the roller. According to the structure of the present invention, a part of the outer circumferential surface of the roller, to which the separating claw is opposed, has higher hardness than the tip of the separating claw. Therefore, even if a jam occurs and the tip of the separating claw is pressed to the roller, the roller is not scratched or dented. Therefore, it is possible to prevent the roller from being damaged by the separating claw.

In an embodiment of the present invention, a part of the roller to which the separating claw is opposed is made of metal, while the tip of the separating claw is made of resin.

In this structure, when a jam occurs and the tip of the separating claw is pressed to the roller, the tip of the separating claw is deformed. Therefore, the roller is not scratched or dented. Thus, it is possible to prevent the roller from being damaged by the separating claw.

### BRIEF DESCRIPTION OF THE DRAWINGS

FIG. 1 is a schematic diagram of a conventional image forming apparatus, illustrating a state when a jam has occurred.

FIG. 2 is a schematic diagram of an image forming apparatus according to an embodiment of the present invention.

FIG. 3A is a schematic diagram of a separating device according to the embodiment of the present invention, illustrating a normal state.

FIG. 3B is a perspective view illustrating a positional relationship between the separating claw and the intermediate transfer belt drive roller.

FIG. 4A is a front cross sectional view of the intermediate transfer belt drive roller.

FIG. 4B is a front view illustrating an external appearance of the intermediate transfer belt drive roller illustrated in FIG. 4A and a positional relationship between the separating claw and the intermediate transfer belt.

FIG. 5A is a front cross sectional view of an intermediate transfer belt drive roller of a different form from that illustrated in FIGS. 4A and 4B.

FIG. 5B is a front cross sectional view of the intermediate transfer belt drive roller illustrated in FIG. 5A, in which a rubber layer is removed.

FIG. 5C is a front view illustrating an external appearance of the intermediate transfer belt drive roller illustrated in FIG. 5A and a positional relationship between the separating claw and the intermediate transfer belt.

FIG. 6A is a perspective view illustrating a positional relationship between the intermediate transfer belt drive roller and separating claws.

FIG. 6B is a front view illustrating an external appearance of the intermediate transfer belt drive roller in the case where a plurality of separating claws are disposed and a positional relationship between the intermediate transfer belt and the separating claws.

### DETAILED DESCRIPTION OF THE INVENTION

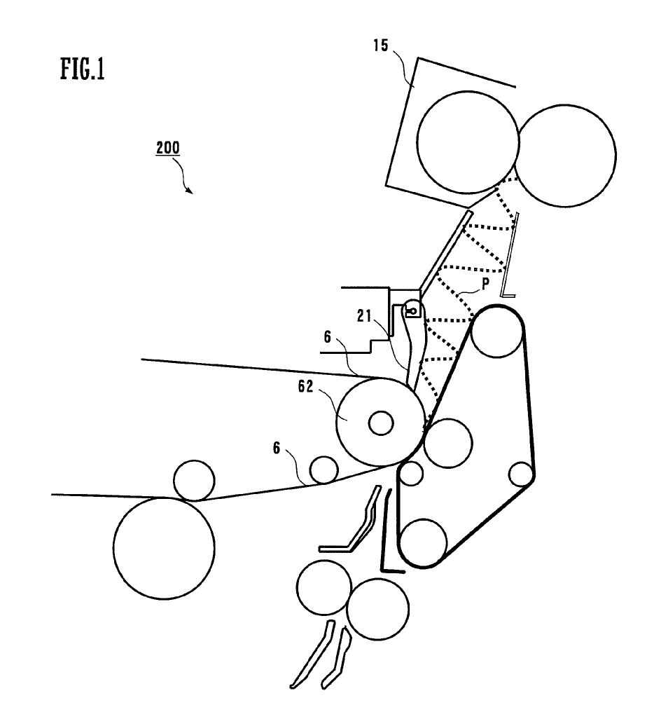

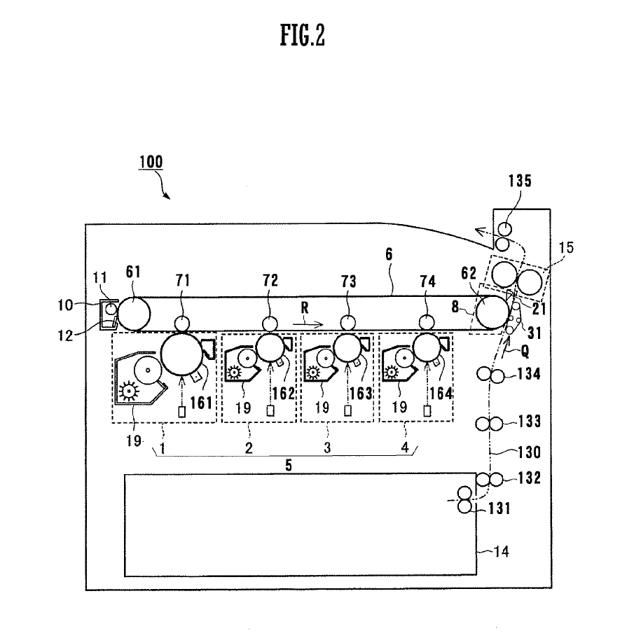

First, a schematic structure of an image forming apparatus 100 equipped with a separating device according to an embodiment of the present invention is described with reference to FIG. 2. Note that in the image forming apparatus 100, the same components as in the image forming apparatus 200 illustrated in FIG. 1 are denoted by the same numerals or symbols.

The image forming apparatus 100 is a tandem color image forming apparatus including a first image forming unit 1 for forming a yellow toner image, a second image forming unit 2 for forming a magenta toner image, a third image forming unit 3 for forming a cyan toner image, and a fourth image forming unit 4 for forming a black toner image. Hereinafter, the four image forming units of the image forming apparatus 100 are collectively referred to as an image forming unit group 5.

In FIG. 2, an intermediate transfer belt (endless belt) 6 is disposed above the image forming unit group 5. The intermediate transfer belt 6 runs around a support roller 61, an intermediate transfer belt drive roller 62 (hereinafter referred to as a drive roller 62) like a loop in a tensioned state, and turns in the direction indicated by arrow R. The intermediate transfer belt 6 is made of polyimide material containing electron conductive material. The film thickness of the intermediate transfer belt 6 is 60 to 80 μm, for example. The polyimide material is a polymer that has highest heat resistance among organic materials and is superior in mechanical characteristic, electrical insulation, environmental stability, and chemical resistance. Therefore, the intermediate transfer belt 6 is superior in durability.

The image forming unit group 5 includes the first image forming unit 1, the second image forming unit 2, the third image forming unit 3, and the fourth image forming unit 4, arranged in this order along the intermediate transfer belt 6 in the direction of arrow R.

On the inner circumferential side of the intermediate transfer belt 6, there are disposed primary transfer rollers 71, 72, 73, and 74 for transferring single color toner images formed by the image forming unit group 5 to the intermediate transfer belt 6. The primary transfer rollers 71, 72, 73, and 74 sustain the intermediate transfer belt 6 in a tensioned state, and are respectively opposed to photoconductor drums (image carriers) 161, 162, 163 and 164 of the image forming unit group 5 via the intermediate transfer belt 6. The single color toner images formed by the image forming unit group 5 are transferred (as primary transfer) onto the intermediate transfer belt 6 in a superposed manner, so that one color toner image is formed. The intermediate transfer belt 6 conveys the toner image after the primary transfer to the position where the drive roller 62 and a secondary transfer belt 310 described later are opposed to each other (a secondary transfer position). Hereinafter, in rotation direction R of the intermediate transfer belt 6, a side of the support roller 61 is referred to as the upstream side, and a side of the drive roller 62 is referred to as the downstream side.

A secondary transfer unit 31 is disposed at the secondary transfer position that is opposed to the drive roller 62 via the intermediate transfer belt 6. The color toner image formed on the intermediate transfer belt 6 is transferred to a paper sheet (corresponding to a recording medium) P by electrostatic force at the secondary transfer position where the drive roller 62 and the secondary transfer unit 31 are opposed to each other. At the secondary transfer position, the intermediate transfer belt 6 (the drive roller 62) is provided with a separating claw 21 for separating the paper sheet P when it winds around the same. A separating device 8 is constituted of the drive roller 62 and the separating claw 21.

A belt cleaning unit 10 for cleaning the surface of the intermediate transfer belt 6 is disposed at the position opposed to the support roller 61 via the intermediate transfer belt 6. The belt cleaning unit 10 includes a belt cleaning brush 11 disposed to contact with the intermediate transfer belt 6, and a belt cleaning blade 12, so as to remove the toner remaining on the intermediate transfer belt 6 without being transferred to the paper sheet P.

In FIG. 2, a tray 14 for housing paper sheets is disposed below the image forming unit group 5. The paper sheet in the tray 14 is conveyed by a plurality of paper feed rollers 131 to 134, in the paper sheet convey direction indicated by arrow Q to the secondary transfer position where the secondary transfer belt 310 is opposed to the intermediate transfer belt 6. In this secondary transfer position, the color toner image on the intermediate transfer belt 6 is secondarily transferred to the paper sheet P.

The paper sheet P to which the color toner image is secondarily transferred is conveyed to a fixing unit 15. Then, the color toner image is fixed to the paper sheet P by the fixing unit 15, which is delivered by a delivery roller pair 135 to the outside of the image forming apparatus 100.

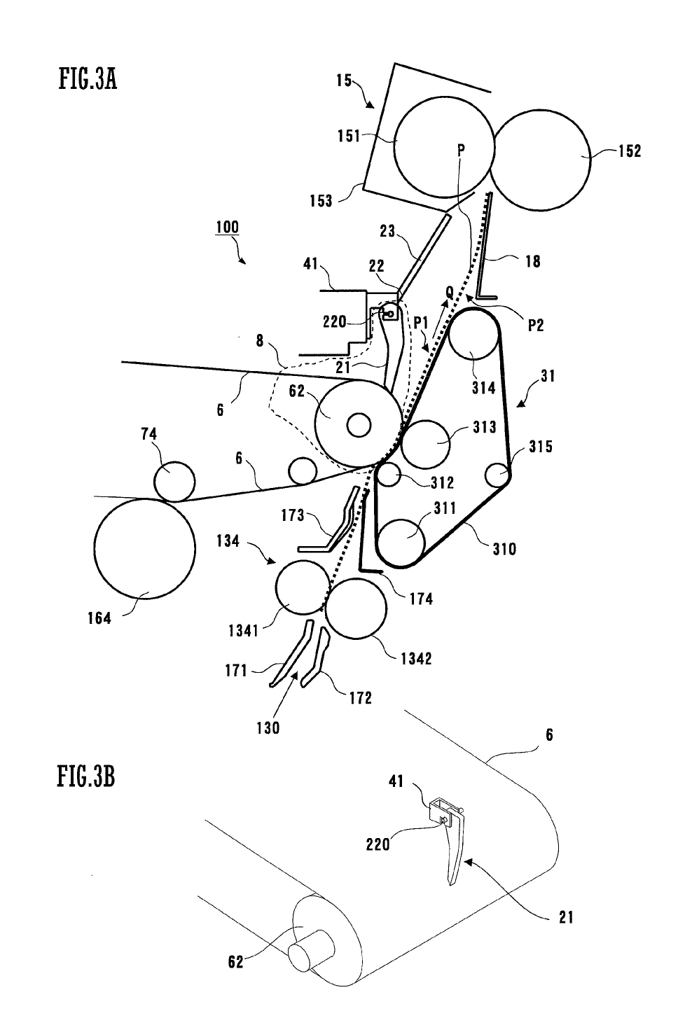

Next, a specific structure of the separating device and periphery thereof is described. FIG. 3A illustrates a state where the image forming apparatus 100 normally conveys the paper sheet P (indicated by a dot line).

As illustrated in FIG. 3A, the image forming apparatus 100 includes, in order from an upstream side to a downstream side in the convey path 130 opposed to one side P1 of the paper sheet P that is conveyed in the direction of arrow Q in the convey path, a convey guide 171, a roller 1341 of the paper feed roller pair 134, a convey guide 173, the drive roller 62 (the intermediate transfer belt 6) and the separating claw 21 of the separating device 8, a support member 22, a retreat convey guide 23, a roller cover 153 of the fixing unit 15, and a heat roller 151 of the fixing unit 15. In addition, it includes, in order from the upstream side to the downstream side in the convey path 130 opposed to the other side P2 of the paper sheet P, a convey guide 172, a roller 1342 of the paper feed roller pair 134, a convey guide 174, a secondary transfer unit 31, a convey guide 18, and a pressure roller 152 of the fixing unit 15.

The secondary transfer unit 31 includes the secondary transfer belt (the endless belt) 310, a support roller 311, a secondary transfer auxiliary roller 312, a secondary transfer roller 313, a secondary transfer belt drive roller 314, and a support roller 315. The secondary transfer belt 310 runs around the rollers 311 to 315 like a loop in a tensioned state.

The paper sheet P is conveyed by the paper feed roller pair 134, by the intermediate transfer belt 6 and the secondary transfer belt 310, and by the heat roller 151 and the pressure roller 152 of the fixing unit 15, along the convey path 130.

As illustrated in FIG. 3A, the separating claw 21 is pivoted by a pin 220 in a swinging manner with respect to a separating claw holder 41, and the tip thereof slightly contacts with the intermediate transfer belt 6. The tip of the separating claw 21 is made of resin. It is preferred that the resin used for the tip of the separating claw 21 has flexibility and lower hardness than materials of a rubber layer 627 and a metal layer 637 that will be described later, like Esubea N9240 (produced by STARLITE Co., Ltd), for example.

FIG. 3B illustrates an example in which one separating claw 21 is disposed at the middle portion in the rotation axis direction of the intermediate transfer belt 6. When the toner image carried on the intermediate transfer belt 6 is transferred to the paper sheet (the recording medium) P, if the paper sheet P winds around the intermediate transfer belt 6, the separating claw 21 separates the paper sheet P from the intermediate transfer belt 6 by the tip.

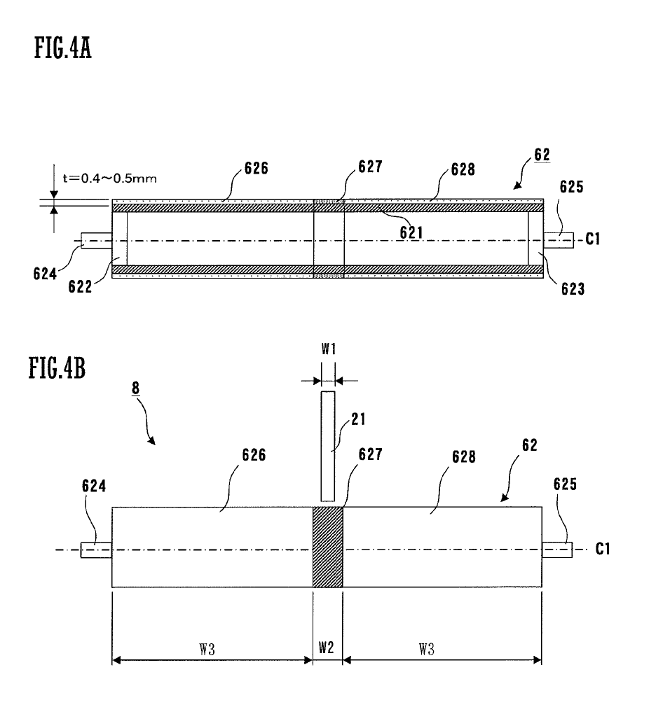

As illustrated in FIGS. 4A and 4B, the drive roller 62 of the separating device 8 includes a cylindrical metal core part 621 and rubber layers 626 to 628 adhered to the outer circumferential surface of the metal core part 621. Note that the intermediate transfer belt 6 is omitted in FIG. 4B.

The metal core part 621 is constituted of a thin pipe made of an aluminum alloy (Al—Cu), the ends of which are sealed with disc lids 622 and 623 made of an aluminum alloy. At the centers of the disc lids 622 and 623, rotation shafts 624 and 625 made of stainless steel are pressed in. The outer diameter of the metal core part 621 is 25 to 35 mm, for example.

The rubber layers 626 to 628 are made of EPDM blend rubber having electrical conductivity. The thickness t of the rubber layers 626 to 628 is 0.4 to 0.5 mm, for example.

The rubber layer 627 is adhered in a cylindrical manner to a part of the outer circumferential surface of the metal core part 621 to which the separating claw 21 is opposed. The rubber layer 627 has a width W2 wider than a width W1 of the separating claw 21 in the direction parallel to the center line C1 connecting the rotation shaft 624 and the rotation shaft 625. Thus, even if the separating claw 21 swings, the tip of the separating claw 21 can always contact with the rubber layer 627. The rubber layer 627 is made of material having higher hardness than the tip of the separating claw 21, that is, for example, a hardness of 60 degrees measured by JISA.

The rubber layer 626 is adhered to the outer circumferential surface of the metal core part 621 in a cylindrical manner from one end of the rubber layer 627 to one end of the metal core part 621. The rubber layer 628 is adhered to the outer circumferential surface of the metal core part 621 in a cylindrical manner from the other end of the rubber layer 627 to the other end of the metal core part 621. FIGS. 4A and 4B illustrate the case where the width of each of the rubber layers 626 and 628 is set to W3.

Hardness of the rubber layers 626 and 628 is not limited to a specific value. However, by using material having lower hardness than the intermediate transfer belt 6, abrasion of the back surface of the intermediate transfer belt 6 can be reduced so that durability of the intermediate transfer belt 6 can be improved compared with the case where a high hardness material is used. However, if the hardness of the rubber layers 626 and 628 is excessively low, dimensional accuracy of the drive roller cannot be secured, and in particular, a problem such as color shift may occur when a color image is formed. Therefore, it is necessary to set the hardness of the rubber layers 626 and 628 regarding the dimensional accuracy as important.

In this way, in the separating device 8, the rubber layer 627 having higher hardness than the tip of the separating claw 21 is disposed on the outer circumferential surface of the drive roller 62 to which the separating claw 21 is opposed, thereby a damage to the drive roller 62 can be prevented, even if a jam occurs and the separating claw 21 is pressed by the folded paper sheet P so that the tip of the separating claw 21 is pressed to the drive roller 62.

In addition, by setting the hardness of the rubber layer 627 of the drive roller 62 to be higher than that of the separating claw 21 as described above, a damage to the intermediate transfer belt 6 can be prevented. Specifically, because the hardness of the rubber layer 627 of the drive roller 62 is higher than that of the separating claw 21, the rubber layer 627 of the drive roller 62 and the intermediate transfer belt 6 are hardly deformed when being pressed by the separating claw 21 due to occurrence of a jam. Therefore, the intermediate transfer belt 6 is not dented so that no damage is caused to the intermediate transfer belt 6.

Next, a separating device 8′ is described, which is equipped with an intermediate transfer belt drive roller having a different form from the separating device 8. A part of the intermediate transfer belt drive roller to which the separating claw 21 is opposed can be made of metal.

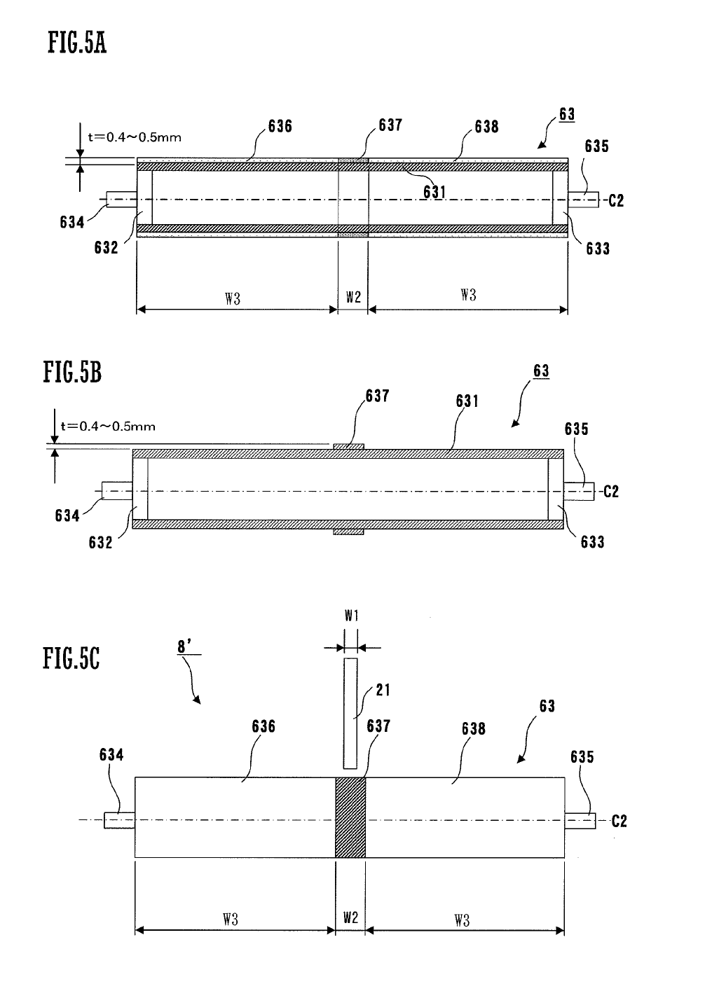

As illustrated in FIG. 5C, the separating device 8′ includes an intermediate transfer belt drive roller 63 (hereinafter referred to as drive roller 63) and the separating claw 21. As illustrated in FIG. 5A, the drive roller 63 includes a cylindrical metal core part 631, a metal layer 637 disposed on the outer circumferential surface of the metal core part 631, and rubber layers 636 and 638 adhered to the outer circumferential surface of the metal core part 631. The rubber layers 636 and 638 are disposed adjacent to the metal layer 637.

The metal core part 631 has the same structure as the metal core part 621 illustrated in FIGS. 4A and 4B, which is constituted of a thin pipe made of an aluminum alloy (Al—Cu), and the ends thereof are sealed with disc lids 632 and 633 made of an aluminum alloy.

As illustrated in FIG. 5B, the metal layer 637 is disposed in a cylindrical manner at a part of the outer circumferential surface of the metal core part 631 to which the separating claw 21 is opposed. The thickness t of the metal layer 637 is 0.4 to 0.5 mm, for example. The metal layer 637 has a width W2 wider than a width W1 of the separating claw 21 in the direction parallel to a center line C2 connecting a rotation shaft 634 and a rotation shaft 635. Thus, even if the separating claw 21 swings, the tip of the separating claw 21 can always contact with the metal layer 637. The metal layer 637 may be formed as a separate body from the metal core part 631 like a metal sheet wound on the outer circumferential surface of the metal core part 631, or may be formed integrally with the metal core part 631 around the outer circumference of the metal core part 631. In addition, the type of metal material of the metal layer 637 is not limited as long as it has higher hardness than the tip of the separating claw 21. If an aluminum alloy (2000 Al—Cu) is used for the metal layer 637, for example, the hardness of the metal layer 637 is 95 to 105 by Brinell hardness HB.

The rubber layer 636 has the same structure as the rubber layer 626 illustrated in FIGS. 4A and 4B, and is adhered to the outer circumferential surface of the metal core part 631 from one end of the metal layer 637 to one end of the metal core part 631 in a cylindrical manner. In addition, the rubber layer 638 has the same structure as the rubber layer 628 illustrated in FIGS. 4A and 4B, is adhered to the outer circumferential surface of the metal layer 637 from the other end of the metal core part 631 to the other end of the metal core part 631 in a cylindrical manner. The rubber layers 636 and 638 are made of EPDM blend rubber having electrical conductivity. FIG. 5C illustrates the case where the widths of the rubber layers 636 and 638 of the separating device 8′ are set to W3 each. The thickness t of the rubber layers 636 and 638 is 0.4 to 0.5 mm, for example. Note that the intermediate transfer belt 6 is omitted in FIG. 5C.

In this way, in the separating device 8′, the metal layer 637 having high hardness than the tip of the separating claw 21 is disposed on the outer circumferential surface to which the separating claw 21 of the drive roller 63 is opposed, and the tip of the separating claw 21 is made of resin having flexibility and lower hardness than the metal material of the metal layer 637. Thus, when a jam occurs and the tip of the separating claw 21 is pressed to the drive roller 63, the tip of the separating claw 21 is deformed, but the drive roller 63 is not deformed. Therefore, it is possible to prevent the drive roller 63 or the intermediate transfer belt 6 from being damaged.

Next, a separating device 8″ is described, which is equipped with an intermediate transfer belt drive roller having a still different form. If the plurality of separating claws 21 are disposed to be opposed to the intermediate transfer belt 6, it is preferred that rubber layers having higher hardness than the tip of the separating claw 21 are disposed on the outer circumferential surface of the intermediate transfer belt drive roller in the parts to which the separating claws 21 are opposed, respectively, in the same manner as illustrated in FIGS. 4A and 4B.

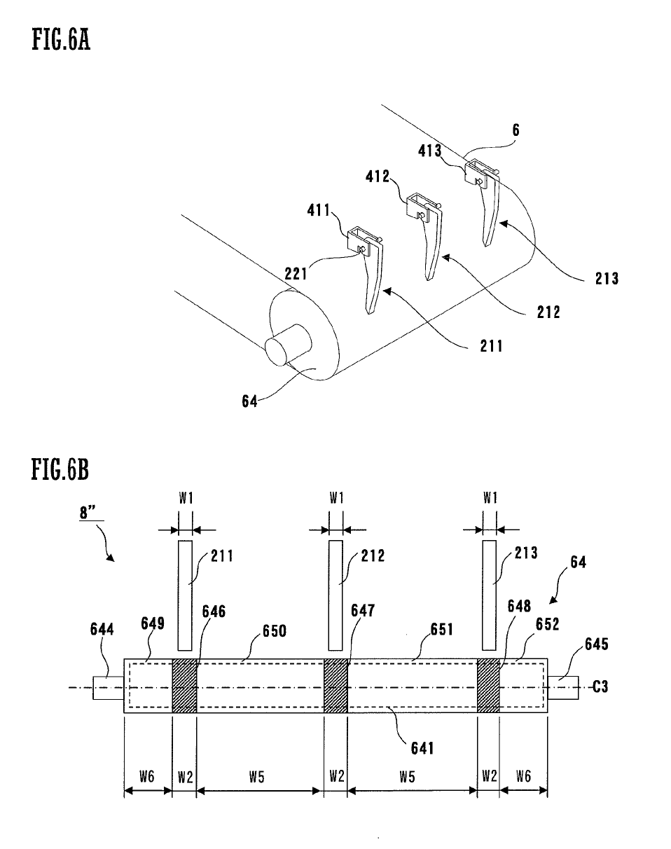

For instance, FIG. 6A illustrates a case where three separating claws 211 to 213 are disposed to be opposed to the intermediate transfer belt 6 (an intermediate transfer belt drive roller 64 (hereinafter referred to as a drive roller 64)). The separating device 8″ includes the drive roller 64 and the separating claws 211 to 213. The separating claw 211 is pivoted by a pin 221 in a swinging manner with respect to a separating claw holder 411. Similarly, the separating claw 212 is pivoted by a pin 222 in a swinging manner with respect to a separating claw holder 412, and the separating claw 213 is pivoted by a pin 223 in a swinging manner with respect to a separating claw holder 413.

In this structure, as illustrated in FIG. 6B, rubber layers 646 to 648 having higher hardness than the tip of the separating claws 211 to 213 are adhered to the drive roller 64 in the parts to which the separating claws 211 to 213 are opposed (outer circumferential surface), respectively, in a cylindrical manner. Each of the rubber layers 646 to 648 has a width W2 wider than a width W1 of the separating claw 21 in the direction parallel to a center line C3 connecting a rotation shaft 644 and a rotation shaft 645. Thus, even if the separating claws 211 to 213 swing, the tips of the separating claws 211 to 213 can always contact with the rubber layers 646 to 648, respectively. In addition, rubber layers 649 to 652 having any hardness are adhered to the drive roller 64 in the parts to which the separating claws 211 to 213 are not opposed (outer circumferential surface of the metal core part 641), in a cylindrical manner. FIG. 6B illustrates the case where the widths of the rubber layers 650 and 651 are set to W5 each, and the widths of the rubber layers 649 and 652 are set to W6 each. Note that the intermediate transfer belt 6 is omitted in FIG. 6B.

Metal layers having higher hardness than the tips of the separating claws 211 to 213 may be disposed instead of the rubber layers 646 to 648 on the drive roller 64, similarly to the case described above with reference to FIG. 5.

By constituting the separating device 8″ in this way, it is possible to prevent the intermediate transfer belt drive roller or the intermediate transfer belt from being damaged when a jam occurs, also in the case where a plurality of separating claws are disposed.

As described above, in the image forming apparatus, because the part of the outer circumferential surface of the intermediate transfer belt drive roller to which the separating claw is opposed has higher hardness than the tip of the separating claw, even if a jam occurs and the separating claw is pressed by the paper sheet so that the tip of the separating claw is pressed to the intermediate transfer belt drive roller, a damage to the intermediate transfer belt drive roller can be prevented.

Note that the description described above is about the structure in which the separating claw is disposed to be opposed to the intermediate transfer belt, but the present invention is not limited to this structure. The present invention can be also applied to a structure in which the separating claw is disposed to be opposed to an intermediate transfer roller. In addition, the present invention can be applied to other structures, as long as the separating claw is disposed to be opposed to a roller. For instance, the present invention can be applied to a fixing device in which the separating claw is disposed to be opposed to a pressure roller or a heat roller of the fixing device. In addition, if a conveying roller for paper is provided with a separating claw, the present invention can be applied to the conveying roller, too.

What is claimed is:

1. A separating device comprising:
a roller disposed in a convey path so as to convey a recording medium; and
a separating claw with a tip disposed to be opposed to a part of the roller so as to separate the recording medium by the tip, the part being made of material having higher hardness than the tip.

2. The separating device according to claim 1, wherein the part is made of rubber and the tip is made of resin having lower hardness than the rubber.

3. The separating device according to claim 1, wherein the part is made of metal and the tip is made of resin.

4. The separating device according to claim 1, wherein a width of the part is larger than a width of the separating claw.

5. The separating device according to claim 1, wherein a plurality of separating claws are disposed along a center axis of the roller.

6. An image forming apparatus comprising:
the separating device according to claim 1; and
an image forming portion for forming an image on a recording medium conveyed by the roller of the separating device.
